(19) United States
(12) Patent Application Publication
(10) Pub. No.: US 2021/0280077 A1
(43) Pub. Date: Sep. 9, 2021

(54) VIRTUAL EDUCATIONAL EXPERIENCE WITH 3D SOUND SPATIALIZATION

(71) Applicants: James Ouyang, Cupertino, CA (US); Gauri Shri Thirumandas, Cupertino, CA (US); Hudson Taylor Treloar, Silverado, CA (US)

(72) Inventors: James Ouyang, Cupertino, CA (US); Gauri Shri Thirumandas, Cupertino, CA (US); Hudson Taylor Treloar, Silverado, CA (US)

(73) Assignees: James Ouyang, Cupertino, CA (US); Gauri Shri Thirumandas, Cupertino, CA (US); Hudson Taylor Treloar, Silverado, CA (US)

(21) Appl. No.: 16/810,851

(22) Filed: Mar. 6, 2020

(51) Int. Cl. G09B 7/06; G09B 7/02; A63F 9/18; H04W 4/02; H04S 1/00; G06F 8/38

(52) U.S. Cl. CPC G09B 7/06; G09B 7/02; A63F 9/183; H04S 2400/11; H04S 1/005; G06F 8/38; A63F 2300/8064; H04W 4/026

(57) ABSTRACT

The present invention discloses a multiple-choice-question based quiz platform facilitating the generation, development, delivery, and management of educational tests with interactive participation by students in terms of visual and audio guidance. The system utilizes 3D virtual sound spatialization and the movement and orientation of a mobile computing device to enhance the learning experience of users. Each quiz question and answer choice is associated with a certain orientation of the mobile device and a 3D virtual sound of a certain direction. By completing quizzes in this immersive 3D virtual sound environment, the user enhances his or her learning experience by making learning fun, and enhances his or her memory and retention of the learning content.

### BACKGROUND

### Field of the Invention

The present invention relates to an automated system and method for managing and/or facilitating multiple-choice testing and more particularly to a computer automated system implementing a multiple-choice testing for mobile computers such as smartphones and tablets.

### Description of the Related Art

Listening to movies and music has become more enjoyable with recent advances in technology. Listeners are given a more immersive experience while listening to recordings as a result of spatial audio techniques, which allows virtual sound to be heard from anywhere. The use of stereo systems and headphones provides listeners with the illusion that a sound is traveling from a specific direction, rather than surrounding the user. Due to improvements within audio systems, 3D recordings could now be used for virtual reality as another technique to give users a more realistic experience when they are put in different environments.

The definition of the word “wearables” has changed over time with innovations of micro transistors, leading to the development of smaller computers. Computers nowadays can be small enough to be worn as a watch on a wrist, a display on a head, or a tiny sensor to monitor activities such as steps. Inertial sensors, which consist of an accelerometer, a gyroscope, and a magnetic sensor, can determine motion and direction. Inertial sensors are currently small and light enough to be worn on a user's head. This allows for 3D sound to be replicated with stereo headphones by allowing the user to locate the source of a sound in a 3D virtual space by moving his or her head.

As more students' own smartphones, quiz apps have become increasingly popular since they allow for greater convenience when studying. Most quiz apps use questions in the format of multiple-choice, which is easy for computers to grade and give feedback. Early educational research shows that using multiple-choice questions while studying can be very helpful in learning a range of subjects. Additionally, recent research shows that being active while learning has cognitive benefits, however current quiz apps contain the same traditional interface of multiple-choice questions and lack such physical activity, this application intends to change that.

There are multiple inventions that have been proposed in prior art regarding advancements in field of multiple-choice testing for mobile computers such as smartphones and tablets. For instance, a method and apparatus for improving performance on multiple-choice exams bearing U.S. Pat. No. 5,885,087A is issued to RoboLaw Corp. The patent is on a computerized learning approach that enables a user to improve their performance on multiple-choice exams is disclosed. Although the learning approach includes various aspects and implementations, in general, the invention forces test-takers to practice their examination skills and subject matter knowledge in a systematic way. The systematic way forces the users to follow a proven problem-solving approach designed to improve their performance. The invention provides important performance feedback to user's, for example, elapsed time per question and percentage of correctly answered questions. The invention can also pinpoint for the user the substantive areas of the exam which the user is either weak or strong. Further, the invention is able to assist the user in predicting his/her eventual score.

Another U.S. Pat. No. 6,685,482B2 on Method and system for creating and evaluating quizzes is issued to Theodore H. Hopp Marsha A. Hopp. The patent is on an educational software using a computer and having a data storage system including a software module database management system and a user database management system. There is a quiz module database, maintained by the software module database management system, containing at least one quiz module, and a structured learning material editor module database, maintained by the software module database management system and containing at least one structured learning material editor modules. The software also has a structured learning material database, maintained by the user database management system, for storing at least one structured learning material data set created by a user. A user interface is provided for selecting system control functions, editing structured learning materials, presenting quizzes, receiving user answers to quizzes, and displaying quiz analysis results. A control system retrieves software modules from the software module database management system and activates them.

Another US patent on Interactive quiz-based internet system bearing US patent 2,002,0049634A1 is issued to Joseph Longinotti. The invention relates to an interactive quiz-based internet system that provides for the release of stored prize points to a user after the user has completed an educational quiz.

A Chinese patent 1,026,37170A on question pushing method and system is issued to Chinese inventor. The invention provides a question pushing method and system, which are implemented based on pre-established user models, and the user models include at least two of the following models: an interest model, an attribute model, a behavior model and a relation model, wherein the interest model is established by exploiting questions asked by users and answers thereof, the attribute model is established based on user attributes, the behavior model is established by carrying out statistics on user behaviors, and the relation model is established based on relations between different users. The method comprises the following steps: A, carrying out text analysis on a question to be answered so as to extract question features; B, matching with the user models by using the extracted question features, and carrying out sequencing on users according to the matching degree of the question features with the users in each user model and a preset sequencing weight of each user model; and C, pushing the question to be answered to the front M users in the obtained sequence, wherein M is a preset positive integer. Through the method and system disclosed by the invention, the answer providing efficiency and quality of a knowledge questioning and answering system can be improved.

A Method and system for skills-based testing and training bearing US patent 2,004,0029092A1 is issued to SMTM Tech LLC. The patent is on methods and systems for skills-based testing and training of an application are provided. Example embodiments provide a Skills-Based Simulation and Measurement System “SBSMS”, which enables publishers and authors of tests and training programs to provide simulated application environments for testing and training students. In one embodiment, the SBSMS comprises a client portion and a server portion. The client portion includes a simulation engine that is run by a student and tracks the student's responses. The server portion comprises the components and data that are used to implement the client-side simulation engine and includes a skills-based testing and training engine, simulation components, non-simulation components, and a tests and training scenarios and student data repository. The server portion receives and satisfies requests for portions of a scenario with the simulation and non-simulation components. The server portion engine receives from the client portion student responses and scores and stores them on a per user, per scenario basis in the data repository. The client and server portions cooperate to provide skills-based simulation and measurement in testing and training scenarios.

A Method for Automated Examination Testing and Scoring bearing US patent 2,007,0160971A1 is issued to Paul Caldera Charles Ouellette Carmen Reitano Walter Cheney Geoffrey Cronin. The patent is on a software based method of automatically recording and scoring tests is practiced on a system including a computer, a digital pen and a sheet of digitized paper, the method first establishing a number of virtual fields on the digitized paper, each which may contain either one allowable mark, or a multiplicity of allowable marks, marking of the paper using the digital pen, and for each such mark determining the field in which the mark is made, if the field may contain only one allowable mark, then recording that mark, and if the field may contain more than one allowable mark, then using character recognition means to identify the mark, and then calculating a test result based on the marks made, the characters corresponding to each, and a scoring protocol.

Another US patent on Dynamic online test content generation bearing US patent 2,008,0102431A1 is issued to Houghton Mifflin Harcourt Publishing Co. The patent implies an online test platform facilitates the generation, development, delivery, and management of educational tests with interactive participation by students, teachers, proctors, and administrators even when some or all of them are remotely located. The platform may include a database for storing test assembly information, administrator interfaces, test proctor interfaces, and test taker (e.g. student) interfaces to allow each participant to view, navigate, and interact with aspects of the online test platform that are intended to meet their needs.

There are multiple solutions that have been presented in prior art. However, these solutions are limited and did not fully utilize the modern capabilities of mobile devices, especially the 3D virtual sound effect capability and gyroscope sensors that can detect the heading or orientation of the devices. To overcome the above-mentioned limitation and provide advancement in similar field, the current invention is focused on presenting an advancement by leveraging the these advanced capabilities of modern mobile computing devices, especially the 3D virtual sound capability. The application further includes physical activity as research proves that it maximizes retention among student.

None of the previous inventions and patents, taken either singly or in combination, is seen to describe the instant invention as claimed. Hence, the inventors of the present invention propose to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved quiz system intended to create a learning platform that leverages 3D virtual sound for learning and memorizing content.

It is another objective of the invention to provide a system and method for facilitating teachers and students involving a plurality of talent information users and talent information providers wherein the content of the system can be generated in different subject fields and customized for different communities.

It is also the objective of the invention to provide methods and systems for creating learning content through quiz format and recording and editing 3D virtual sound effects.

It is further the objective of the invention to provide a multiple selection quiz platform using 3D virtual sound to improve the learning experience of the user.

It is another objective of the invention to provide system which includes physical activity as research proving that maximizes retention of learned material.

A further objective is to provide an assembly that is simple and easy to use.

A still further objective is to provide a system that is flexible and scalable.

It is a further objective of the present invention to provide an open platform to allow educators to add and remove their own content in order to tailor it to their educational purpose.

Still yet another objective of the present invention is to provide a new and improved testing system which provides in the apparatuses and methods of the prior art some of the advantages thereof, while simultaneously overcoming some of the disadvantages normally associated therewith.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

One aspect of the present application is to leverage the wide availability of 3D virtual sound capability and gyroscope sensors in modern personal mobile devices in education. The virtual reality audio is an integral part of immersive educational experience, and sensors allows users to move and be active while learning. The proposed application combines both to provide an interactive environment for students to learn in.

The proposed application is intended to create an open platform which can support a diverse community of students and faculty, who can create their own content on the platform and customize the learning experience. The application includes physical activity as research proves that it maximizes memory and retention of the knowledge learned among student.

As per preferred embodiment of the invention the system provides the user a simple interface which allows them to practice quizzing for students to be able to advance their knowledge of a subject and prepare for future examinations.

The system as per its further embodiments allows teachers and educators to design and upload their specific content in their respective subject field. Therefore, their students will be able to leverage the unique virtual sound and motion based immersive learning experience provided by the system.

The system includes a mobile computing device, a pair of stereo headphones connected to the mobile device, and a mobile application software, or app, running on the mobile device. Multiple quizzes corresponding to different subjects are included in the app. Each quiz can be part of a subject (e.g. “Physics” or “Spanish”). A quiz can be accessed by either clicking and entering the quiz directly through a list or by choosing and entering a subject and then clicking the quiz from the list of quizzes belonging to that subject. Upon clicking a quiz, a page of information about the quiz is shown, with an image describing the quiz, a detailed text description, and a play button. When the play button is pressed, the quiz is entered and the first question of the quiz is displayed.

In a quiz, the mobile device can be rotated so that it faces different bearings of a compass (i.e. north, south, east, west). In a single question, the question is always shown on the device's screen regardless of device bearing. Upon entering a question, a voice recording that reads the question is played. In a single question, the total of 360° will be split evenly into the number of answer choices, such that each answer choice corresponds to a range of angles (e.g. 0°-90° for one of four answer choices). The answer choice corresponding to the current device bearing is shown on the device's screen. When the device is rotated enough such that the answer choice changes, a voice recording that reads the new answer choice is played. If the user is wearing headphones, the voice recording is perceived to be coining from the direction of the new answer choice. Said direction being the center of the angle the answer choice is valid for.

There is an evaluation button shown on the screen for each question. When the button is pressed, the answer choice that is currently being shown is evaluated and a new view will be shown, hiding the question and answer choice and showing the question and the correct answer choice. If the user-selected answer choice is evaluated to be correct, the background of the new view will turn green and many voice recordings of praises will be played at random. If the user-selected answer choice is evaluated to be incorrect, the background of the new view will turn red and many voice recordings of disapproval will be played at random.

The new view also has a “cancel” button. When the cancel button is pressed, the view is dismissed and a new question appears. If the question is the last question of the quiz, the summary information of how the user performed in answering the quiz is shown instead.

While the present invention has been particularly described in conjunction with a specific preferred embodiment, it is evident that many alternatives, modifications and variations will be apparent to those skilled in the art in light of the present description. It is therefore contemplated that the appended claims will embrace any such alternatives, modifications and variations as falling within the true scope and spirit of the present invention.

What is claimed is:

1. A method for doing a multiple-choice quiz using a mobile computing device and 3D virtual sound, the method compromising:
displaying the question and answer choices on the screen of the mobile device, where the answer choices will change based on the heading or orientation of the device;
reading the question and answer choices out aloud using 3D virtual sound, based on the heading of the mobile device;
answering the question by clicking a button displayed on the screen of the mobile device, based on the heading of the device;
providing feedback to the user through audio from the mobile device.

2. The method of claim 1, wherein displaying the question and answer choices on the screen of the mobile device, where the answer choices will change based on the heading or orientation of the device, an example implementation is displaying answer choice A when the mobile device is heading towards north, displaying answer choice B when the mobile device is heading towards west, displaying answer choice C when the mobile device is heading towards south, displaying answer choice D when the mobile device is heading towards east.

3. The method of claim 1, wherein reading the question and answer choices out aloud using 3D virtual sound, based on the heading of the mobile device, an example implementation is reading the question out aloud using 3D virtual sound so that the user feels that the sound is from up above, reading answer choice A so that the user feels that the sound is from his front, reading answer choice B so that the user feels that the sound is from his left, reading answer choice C so that the user feels that the sound is from his behind, reading answer choice D so that the user feels that the sound is from his right.

4. The method of claim 1, wherein answering the question by clicking a button displayed on the screen of the mobile device, based on the heading of the device, an example implementation is the button for correct answer choice A will appear on the screen only when the mobile device is heading towards north, the button for correct answer choice B will appear on the screen only when the mobile device is heading towards west, the button for correct answer choice C will appear on the screen only when the mobile device is heading towards south, the button for correct answer choice D will appear on the screen only when the mobile device is heading towards east.

5. The method of claim 1, wherein providing feedback to the user through audio from the mobile device, an example implementation is when the user answered the question correctly, he will hear a pleasant 3D virtual sound “yes, you answered correctly!” from up above; when the user answered the question incorrectly, he will hear a unpleasant 3D virtual sound “no, your answer was wrong!” from down below.

6. A system for creating and running quizzes using 3D virtual sound, comprising of:
sound recording system for recording quiz questions and answer choices;
sound editing and analysis system for analyzing and editing the sound recordings;
integrated development environment, or IDE, to create quiz content and combine 3D virtual sound effect onto a mobile computing device;
mobile computing device such as a smart phone or tablet that has gyroscope sensors and can detect the heading or orientation of the device;
listening device connected to the mobile computing device to allow user access to 3D virtual sound effects;
through sound editing system and IDE, associate the 3D virtual sound of the quiz question to up above direction, down below direction, or any other direction such as north, sound, west, east, so that the user feels that the sound is coining from that direction;
through sound editing system and IDE, associate the 3D virtual sound of the quiz answer choice A to the front of the user while allowing the screen to display answer choice A only when the mobile device is heading towards north;
through sound editing system and IDE, associate the 3D virtual sound of the quiz answer choice B to the left of the user while allowing the screen to display answer choice B only when the mobile device is heading towards west;
through sound editing system and IDE, associate the 3D virtual sound of the quiz answer choice C to the behind of the user while allowing the screen to display answer choice C only when the mobile device is heading towards south;
through sound editing system and IDE, associate the 3D virtual sound of the quiz answer choice D to the right of the user while allowing the screen to display answer choice D only when the mobile device is heading towards east;
through sound editing system and IDE, associate the 3D virtual sound of the feedback to user's answer, such as “yes, you are correct”, or “no, you are wrong”, to a direction from up above, or down below, or from any other directions, with different tones.

7. The system in claim 6, wherein there are four answer choices A, B, C, D associated with four directions of north, west, south, east; but the system is not limited to these four answer choices. For example, there can be eight answer choices associated with eight directions of north, northwest, west, southwest, south, southeast, east, northeast.

8. The system in claim 6, wherein the sound recording system can include a Sennheiser ME 67 shotgun microphone, Sound Devices MM-1 Portable Preamp, and a K-Tec Avalon KE-89cc pole used to extend the microphone, or similar equipments from other manufacturers.

9. The system in claim 6, wherein the sound editing and analysis system can include a Sonic Visualizer for creating spectrogram to analyze sound waveforms, frequency ranges, and volume, and Audacity for editing sound, or other similar systems from other vendors.

10. The system in claim 6, wherein the integrated development environment to create quiz content and combine 3D virtual sound effect onto a mobile computing device can include XCode and Swift for iOS programming, or other similar systems from other mobile computing platforms.
